(19) United States
(12) Patent Application Publication
(10) Pub. No.: US 2025/0121548 A1
(43) Pub. Date: Apr. 17, 2025

(54) SUPERCRITICAL FLUID-ASSISTED POLYMER EXTRUSION FOAMING DEVICE

(71) Applicant: Atlantic Global Enterprises, Inc., Pepperell, MA (US)

(72) Inventors: Jiaquan Bin, Dongguan (CN); Jiaqi Bin, Dongguan (CN)

(21) Appl. No.: 18/917,121

(22) Filed: Oct. 16, 2024

(30) Foreign Application Priority Data
Oct. 17, 2023 (CN) 202311344508
Oct. 17, 2023 (CN) 202322785278

(51) Int. Cl. B29C 48/74; B29C 48/00; B29C 48/42; B29C 48/72

(52) U.S. Cl. CPC B29C 48/74; B29C 48/0012; B29C 48/42; B29C 48/72; B29C 2948/92019; B29C 2948/9238

(57) ABSTRACT

An extrusion foaming device uses pressurized working fluid as a self-sealing medium between a foaming extruder and an extrusion screw transport section in a feed tube. Shaft diameter of the extrusion screw increases in a compression section such that material therein is compressed. Material from a foaming extruder is split between the compression and transport sections and a bypass valve connected to both sections allows adjustment of pressure in the compression section and the valve. Keeping pressure above saturation pressure of a dissolved supercritical fluid in the working fluid inhibits precipitation thereof and intrusion of precipitate into the extrusion section.

### TECHNICAL FIELD

The disclosure relates generally to polymer extrusion and, more particularly, to extrusion foaming in which polymers are extruded with supercritical fluid-assisted foaming. More particularly, aspects of the disclosure relate to a polymer extrusion foaming device, in particular to inhibiting precipitation of the supercritical fluid and intrusion of precipitate into an extrusion section of the device.

### BACKGROUND

Supercritical fluid extrusion foaming is an advanced polymer material processing technology. During the extrusion process, supercritical fluid (usually non-reactive gases, such as carbon dioxide or nitrogen) is first injected into the extruder barrel or tube. Under the action of screw shear and mixing, the supercritical fluid rapidly diffuses and dissolves in the polymer. The polymer/supercritical fluid homogeneous solution is formed in the melt, then, the homogeneous solution is extruded through the die of the extruder. Due to the pressure drop at extrusion, the dissolved supercritical fluid rapidly precipitates out and the melt is extruded. A large number of bubble nuclei are induced in the extruded melt. During a subsequent cooling process, the bubble nuclei inside the extruded melt continue to grow and shape, producing microporous foamed plastic extruded products, also referred to as microcellular foamed plastic extruded products. The advantages enjoyed by the resulting microporous plastic products include light weight, high specific strength, good ability to absorb impact loads, thermal insulation, sound insulation buffering, insulation, and anti-corrosion. Therefore, the technique is widely used to produce microporous foamed plastic extruded products for use in construction, automobiles, medicine, footwear materials, electronics, food packaging, and other industries.

Currently, equipment types for supercritical fluid-assisted extrusion molding of microporous or microcellular foamed plastic parts (including plates, sheets, profiles, films, etc.) include single-screw, twin-screw, and dual-stage extruders (also referred to as two-stage extruders). A two-stage extruder has two independent extrusion units, a foaming extruder and a cooling extruder, connected in series. The foaming extruder is mainly responsible for the melting and plasticizing of plastic particles, as well as supercritical fluid injection and mixing to form a polymer/supercritical fluid homogeneous solution. The cooling extruder is mainly responsible for control of the temperature of the homogeneous solution to obtain the desired foam parts through stable and high-quality extrusion molding. The two-stage extruder has the advantages of high production efficiency, stable product quality, and low energy consumption, so that the two-stage extruder is the most widely used molding equipment in the extrusion foaming industry.

When using a two-stage extruder for supercritical fluid extrusion foaming production, it is important to prevent the polymer/supercritical fluid from the homogeneous solution from being transported from the foaming extruder to the cooling extruder. The supercritical fluid dissolved in the polymer melt can precipitate from the melt due to local pressure drop. The precipitated gas can subsequently leak from the mechanical assembly gap or clearance at the rear of the cooling extruder. The leakage of gas leads to a significant reduction in the concentration of supercritical fluid dissolved in the polymer melt, affecting the foaming effect and potentially reducing the quality of extruded foam parts. A current solution is to include graphite packing at the tail end of the cooling extruder tube to seal the assembly gap between the screw and the tube, which can prevent gas leakage. However, the screw directly contacts the graphite seal(s) so that during use, the high-speed rotation of the screw in the tube causes deformation and wear of the graphite packing. The tail end of the cooling extruder must therefore be periodically disassembled and reassembled to maintain or replace the graphite packing to ensure the sealing effect. This not only increases maintenance costs, but also interrupts operation of the equipment, which reduces the production efficiency of extrusion foaming.

### BRIEF DESCRIPTION

All aspects, examples and features mentioned below can be combined in any technically possible way.

An aspect of the disclosure provides an extrusion foaming device, comprising: a feed tube; and an extrusion screw arranged in the feed tube for rotation therein, wherein the extrusion screw includes a shaft, a compression section with a first helical thread on the shaft, a separation section on the shaft adjacent the compression section, and a transport section adjacent the separation section opposite the compression section, wherein the transport section includes a second helical thread on the shaft, and wherein a first orientation of the first helical thread is opposite a second orientation of the second helical thread, wherein the first helical thread, the second helical thread, and the separation section have an outer diameter sized to provide a sealing relationship with an inner surface of the feed tube and to allow rotation of the extrusion screw relative to the feed tube, and wherein a diameter of the shaft in the compression section increases along a length of the shaft

Another aspect of the disclosure includes any of the preceding aspects, and further comprising a first feed port through the feed tube at an end of the compression section at which the diameter of the shaft is smallest, a discharge port at an opposite end of the compression section at which the diameter of the shaft is largest, and a drive system connected to the extrusion screw such that rotation of the extrusion screw moves material from the first feed port to the discharge port with the first helical thread.

Another aspect of the disclosure includes any of the preceding aspects, and further comprising a bypass valve with a valve body defining a feed passage in fluid communication with the discharge port of the feed tube, a stepped passage in fluid communication with the feed passage, and a discharge passage in fluid communication with the stepped passage, wherein the bypass valve includes a spool body slidably arranged in the stepped passage at an intersection of the stepped passage and the discharge passage, wherein a position of the spool body is adjustable to control a pressure in the stepped passage.

Another aspect of the disclosure includes any of the preceding aspects, and wherein the stepped passage of the bypass valve includes a first section and a second section, wherein a diameter of the first section is larger than a diameter of the second section such that a shoulder is formed between the first section and the second section.

Another aspect of the disclosure includes any of the preceding aspects, and wherein the spool body is arranged in the second section of the stepped passage, a head is attached to the spool body, and the head is in the first section of the stepped passage, wherein a diameter of the head is larger than the diameter of the second section and the shoulder prevents travel of the head into the second section.

Another aspect of the disclosure includes any of the preceding aspects, and wherein an adjustment screw extends from an end of the valve body into the stepped passage to engage the head, and rotation of the adjustment screw changes the position of the spool body.

Another aspect of the disclosure includes any of the preceding aspects, and wherein a spring is arranged between the adjustment screw and the head.

Another aspect of the disclosure includes any of the preceding aspects, and further comprising a pressure sensor arranged to provide an indication of a pressure in the second section of the stepped passage.

Another aspect of the disclosure includes any of the preceding aspects, and wherein the discharge passage of the valve body is in fluid communication with a second feed port through the feed tube.

An aspect of the disclosure provides an extrusion foaming device comprising: a foaming extruder including a die; a feed tube with an extrusion screw centrally disposed therein and supported for relative rotation thereto, wherein the extrusion screw includes a compression section having a first helical thread with a first orientation, a transport section having a second helical thread with a second orientation that is opposite the first orientation, and a partition section between the compression section and the transport section, wherein the partition section is sized to define a clearance between an outer surface thereof and an inner surface of the feed tube that allows rotation of the partition section relative to the feed tube while impeding flow of material between the compression section and the transport section; and a connector between the die and the feed tube, the connector defining a fluid channel extending from an inlet at a die end of the connector to first and second outlets at a feed tube end of the connector, wherein the first outlet is in fluid communication with a first feed port of the tube at an end of the compression section of the extrusion screw, and the second outlet is in fluid communication with a second feed port of the feed tube at an end of the transport section of the extrusion screw.

Another aspect of the disclosure includes any of the preceding aspects, and wherein the extrusion screw includes a shaft from which the first helical thread and the second helical thread project, an outer diameter of the second helical thread is constant over a length of the compression section, and a diameter of the shaft in the compression section increases along a length of the shaft, thereby defining a melt cavity with the inner surface of the feed tube, the partition section, and a sealing section of the extrusion screw at an end of the compression section opposite the separation section.

Another aspect of the disclosure includes any of the preceding aspects, and wherein the clearance between the partition section and the inner surface of the feed tube is from about 0.02 mm to about 0.1 mm.

Another aspect of the disclosure includes any of the preceding aspects, and further comprising a discharge port of the feed tube at an end of the compression section opposite the first feed port, and a bypass valve with a valve body defining a stepped passage, a feed passage, and a discharge passage, wherein the feed passage is in fluid communication with the discharge port of the feed tube and with the stepped passage, wherein the discharge passage is in fluid communication with the stepped passage and a third feed port of the feed tube over the transport section of the extrusion screw, and wherein the bypass valve includes a spool slidably disposed in the stepped passage.

Another aspect of the disclosure includes any of the preceding aspects, and wherein the spool includes a head in a first section of the stepped passage and a spool body extending from the head into a second section of the stepped passage, the second section having a smaller diameter than the first section and the stepped passage having a shoulder therebetween.

Another aspect of the disclosure includes any of the preceding aspects, and wherein an adjustment screw extends into the first section of the stepped passage and a spring is positioned between the adjustment screw and the head of the spool, wherein rotation of the adjustment screw changes a biasing force exerted by the spring on the head of the spool.

Another aspect of the disclosure includes any of the preceding aspects, and wherein in operation the foaming extruder includes a homogeneous solution of supercritical fluid and melted polymer that is drawn through the inlet of the connector and into the feed tube via the first and second feed ports, homogeneous solution passing through the first feed port is compressed in the melt cavity by action of the compression section of the extrusion screw and exits the feed tube through the discharge port to enter the bypass valve, whereby the spool maintains a pressure of the homogeneous solution set by rotation of the adjustment screw, wherein the spool body selectively allows homogeneous solution to enter the discharge passage and pass through the third feed port of the feed tube to be moved by the transport section of the extrusion screw.

Another aspect of the disclosure includes any of the preceding aspects, and wherein the bypass valve has a pressure sensor configured to detect a pressure in the second section of the stepped passage, and the adjustment screw sets a position of the spool body to maintain a pressure in the second section of the stepped passage above a saturation pressure of the supercritical fluid.

An aspect of the disclosure provides an extrusion foaming device comprising: a foaming extruder in fluid communication with a connector configured to receive a solution of a polymer and a supercritical fluid at an inlet of the connector, wherein the connector defines a fluid channel extending from the inlet to a first outlet and a second outlet in parallel with the first outlet; a feed tube including a first feed port in fluid communication with the first outlet of the connector, the feed tube further including a discharge port; and an extrusion screw centrally disposed in the feed tube, wherein the extrusion screw includes a shaft and a first helical thread projecting from the shaft in a compression section of the extrusion screw, wherein the compression section extends between the first feed port of the feed tube and the discharge port of the feed tube, a diameter of the shaft increasing along a length of the shaft from the first feed port of the feed tube to the discharge port of the feed tube.

Another aspect of the disclosure includes any of the preceding aspects, and further comprising a bypass valve with a stepped passage in fluid communication with the discharge port of the feed tube and with a second feed port of the feed tube, wherein the extrusion screw further includes a partition section on the shaft between the first feed port and the second feed port.

Another aspect of the disclosure includes any of the preceding aspects, and wherein the stepped passage includes a first section and a second section separated by a shoulder, a diameter of the first section is larger than a diameter of the second section, the bypass valve includes a spool body extending into the second section at an intersection of the second section and a valve discharge passage, and the bypass valve includes an adjustment screw extending into the first section in mechanical communication with the spool body, wherein rotation of the adjustment screw changes a position of the spool body in the second section.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic cross section view of an embodiment of a supercritical fluid polymer extrusion foaming device based on a self-sealing melt according to aspects of the disclosure;

FIG. 2 is an enlarged view of the embodiment shown in FIG. 1 taken at circle A;

FIG. 3 is a schematic cross section view of an embodiment of an extrusion screw according to aspects of the disclosure;

FIG. 4 is a schematic cross section view of an embodiment of a cylinder used in a supercritical fluid polymer extrusion foaming device based on a self-sealing melt according to aspects of the disclosure; and

FIG. 5 is an exploded view of an embodiment of a bypass valve used in a supercritical fluid polymer extrusion foaming device based on a self-sealing melt according to aspects of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a supercritical fluid-assisted polymer extrusion foaming system. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the extrusion system or, for example, the flow of supercritical fluid through one of the extrusion system's components. The term “downstream” corresponds to the direction of flow of the fluid, and the term “upstream” refers to the direction opposite to the flow. The terms “forward” and “aft,” without any further specificity, refer to directions, with “forward” or “fore” referring to the front end of the extrusion system, and “aftward” or “aft” referring to the rearward end of the extrusion system.

It is often required to describe parts that are at differing radial positions with regard to a center axis. The term “axial” refers to movement or position parallel to an axis, e.g., an axis of an extrusion system. The term “radial” refers to movement or position perpendicular to an axis, e.g., an axis of a extrusion system. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around an axis, e.g., a circumferential interior surface of a casing or housing extending about an axis of an extrusion system. As indicated above, it will be appreciated that such terms may be applied in relation to the axis of the extrusion system.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. In addition, several descriptive terms may be used regularly herein, as described below. The terms “first,” “second,” and “third,” may be used interchangeably to distinguish one component from another and are not intended to signify location or importance of the individual components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur or that the subsequently described component or element may or may not be present and that the description includes instances where the event occurs or the component is present and instances where the event does not occur or the component is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

As indicated above, aspects of the disclosure provide a supercritical fluid-assisted polymer extrusion foaming device, which is further described in detail below in combination with embodiments and drawings, which embodiments and description are non-limiting examples of aspects of the disclosure. Broadly, a homogeneous solution of a melted polymer and a supercritical fluid, such as carbon dioxide, is formed in a foaming extruder. The solution is directed through a connector that divides the solution between a melt cavity and a melt extrusion cavity through first and second feed inlets or ports of a feed barrel or tube of a cooling extruder. The solution is compressed in the melt cavity and is transported in the melt extrusion cavity by oppositely oriented sections of an extrusion screw in the feed tube. In the melt cavity, the solution also travels to a discharge port. A bypass valve connected to the discharge port and to a third feed port in the melt extrusion cavity allows control of pressure in the melt cavity. By maintaining pressure in the melt cavity above the saturation pressure of the supercritical fluid, precipitation of the supercritical fluid is inhibited, and the solution (melt) itself acts as a seal against flow of any precipitated supercritical fluid into the melt extrusion section. Thus, the melt is self-sealing and enters the melt extrusion cavity after passing through the bypass valve, where it is mixed and then continuously extruded and molded to produce microcellular foaming parts. The self-sealing nature of the device according to aspects of the disclosure is simpler in structure, greatly reducing the need for periodic disassembly for maintenance, increasing operation time and efficiency of extrusion foam production.

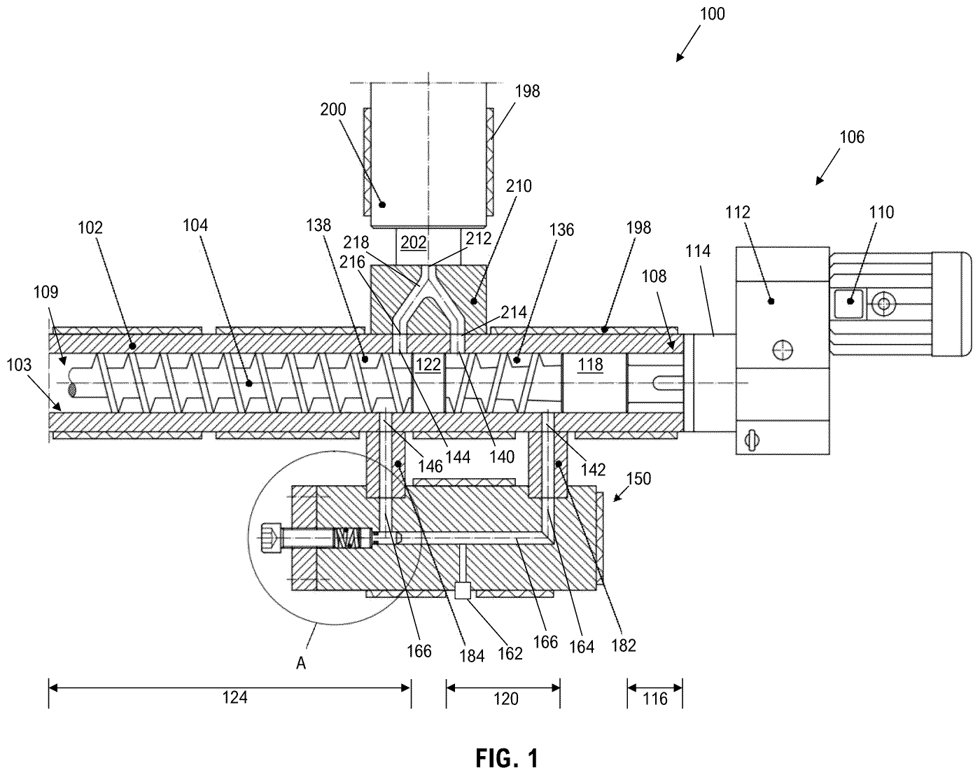

With reference to the accompanying drawings, FIGS. 1-5 show an embodiment of an extrusion foaming device 100, such as a cooling extruder of a dual-stage or two-stage supercritical fluid polymer extrusion foaming system, according to aspects of the disclosure, which is based on a self-sealing melt and includes a feed tube 102, also referred to as a feed barrel, in which an extrusion screw 104 is arranged. A drive system 106 is connected to a tail or rear end 108 of extrusion screw 104. Drive system 106 can include an extruder motor 110 and in embodiments can have a transmission 112, such as a reducer or reduction transmission, interposed between extruder motor 110 and rear end 108 of extrusion screw 104. In embodiments, extruder motor 110 can be an electric motor, though other types of motors or sources of rotation can be employed as may be suitable or desired. Likewise, transmission 112 in some embodiments can include toothed gears, but in other embodiments can use hydrostatic transmissions, pulleys, or other types of transmissions as may be suitable and/or desired. Further, transmission 112 may step up or reduce rotational speed provided by motor 110 to achieve suitable speeds of rotation of extrusion screw 104. For example, transmission 112 may be a reducer so as to increase torque applied to extrusion screw 104.

As schematically illustrated in FIG. 1, drive system 106 is connected to rear end 108 of extrusion screw 104 via a coupling 114. When drive system 106 is active, it turns or rotates extrusion screw 104, which cooperates with an inner surface 103 of feed tube 102 to move or otherwise act on material in feed tube 102 as well be explained below. For example, inner surface 103 of feed tube 102 and extrusion screw 104 can define a melt cavity 136, such as a high pressure melt cavity, and a melt extrusion cavity 138 as will be explained below. A foaming extruder 200 is in fluid communication with feed tube 102 via a connector 210 that splits material exiting foaming extruder 200 to enter melt cavity 136 and melt extrusion cavity 138. Heating devices 198, such as electric heating sleeves, electric heating rings, or the like, can be placed on or around parts of device 100, such as around feed tube 102 and foaming extruder 200, to allow heating thereof and of material residing therein. During operation, material exits foaming extruder 200, enters connector 210, and is conveyed to melt cavity 136 and melt extrusion cavity 138. Material in melt cavity 136 is pressurized by extrusion screw 104 and enters a bypass valve 150 that is also in communication with melt extrusion cavity 138, to which material from melt cavity 136 is conveyed. Material in melt extrusion cavity 138 is conveyed to front end 109 of extrusion 104 and the front end of device 100 overall. By adjusting bypass valve 150, a pressure in melt cavity 136 can be adjusted to reduce or prevent precipitation of supercritical fluid from material therein while allowing the material to proceed to melt extrusion cavity 138.

As more particularly seen in FIG. 3, extrusion screw 104 can include a key connecting section 116, a seal section 118, a compression section 120, a partition section 122 and a transport section 124. Key connecting section 116 can cooperate with coupling 114 (FIG. 1) to connect a shaft 126 of extrusion screw 104 to drive system 106. For example, key connecting section 116 can include one of a key 128 or a slot 130 in shaft 126, and coupling 114 (FIG. 1) can include the other of key 128 and slot 130, where key 128 is inserted into and is retained in slot 130 to connect coupling 114 (FIG. 1) and shaft 126 for transmission of rotation therebetween. Seal section 118 can include a thread seal, a tooth seal, or any other suitable seal that allows rotation thereof relative to inner surface 103 of feed tube 102 while limiting leakage from feed tube 102 at rear end 108 of extrusion screw 104.

As seen in FIG. 3, with additional reference to FIG. 1, partition section 122 is cylindrical and is sized to have a gap or clearance with inner surface 103 of feed tube 102 to allow relative rotation between partition section 122 and feed tube 102 while providing a degree of sealing and separation between compression section 120 and transport section 124. For example, a clearance or gap between an outer surface of partition section 122 and inner surface 103 of feed tube 102 can be from about 0.02 mm to about 0.1 mm.

With continued reference to FIG. 3, compression section 120 and transport section 124 of extrusion screw 104 have respective first and second helical threads 132, 134, also referred to as helical coils or ribs, of opposite orientations and rotation directions. The orientations of helical threads 132, 134 and direction of rotation provided by drive system 106 should be selected such that material in both compression section 120 and transport section 124 moves away from partition section 122. For example, first helical thread 132 in compression section 120 can have a left-handed orientation, and second helical thread in transport section 124 can have a right-handed orientation, such that rotation of extrusion screw 104 with its bottom moving into the page of FIG. 1 will result in helical threads 132, 134 drawing material away from partition section 122.

As noted above, extrusion screw 104 cooperates with inner surface 103 of feed tube 102 to define or form melt cavity 136. More specifically, inner surface 103 along compression section 120 of extrusion screw 104, shaft 126 of extrusion screw 104, and helical thread 132 of extrusion screw 104 form or define melt cavity 136. As seen in FIGS. 1 and 3, a diameter of shaft 126 in compression section 120 gradually increases along the extrusion direction of the melt (e.g., away from partition section 122 and/or toward rear end 108 of extrusion screw 104) in melt cavity 136. Thus, as material in melt cavity 136 moves toward rear end 108 of extrusion screw 104, there is less volume available for the material to occupy, and the material is compressed. Melt cavity 136 may also be referred to as a high pressure melt cavity since the desired pressure within melt cavity 136 will significantly exceed ambient atmospheric pressure.

As also noted above, extrusion screw 104 cooperates with inner surface 103 of feed tube 102 to define or form melt extrusion cavity 138. More specifically, inner surface 103 along transport section 124 of extrusion screw 104, shaft 126 of extrusion screw 104, and helical thread 134 of extrusion screw 104 form or define melt extrusion cavity 138. As seen in FIGS. 1 and 3, unlike in compression section 120, a diameter of shaft 126 in transport section 124 does not change along the transport direction therein (e.g., away from partition section 122 and/or toward front end 109 of extrusion screw 104 opposite rear end 108 of extrusion screw 104) in melt extrusion cavity 138. Thus, as material in melt extrusion cavity 138 moves toward front end 109 of extrusion screw 104, the volume available for the material to occupy is essentially unchanged.

As more particularly seen in FIG. 4, feed tube 102 includes a first feed port 140, also referred to as a first inlet, and a discharge port 142, also referred to as an outlet, both of which are in fluid communication with melt cavity 136 along compression section 120 of extrusion screw 104 at inner surface 103 of feed tube 102. In addition, a second feed port 144 and a third feed port 146, also referred to as a second inlet and a third inlet, respectively, are in fluid communication with melt extrusion cavity 138 extending along transport section 124 of extrusion screw 104.

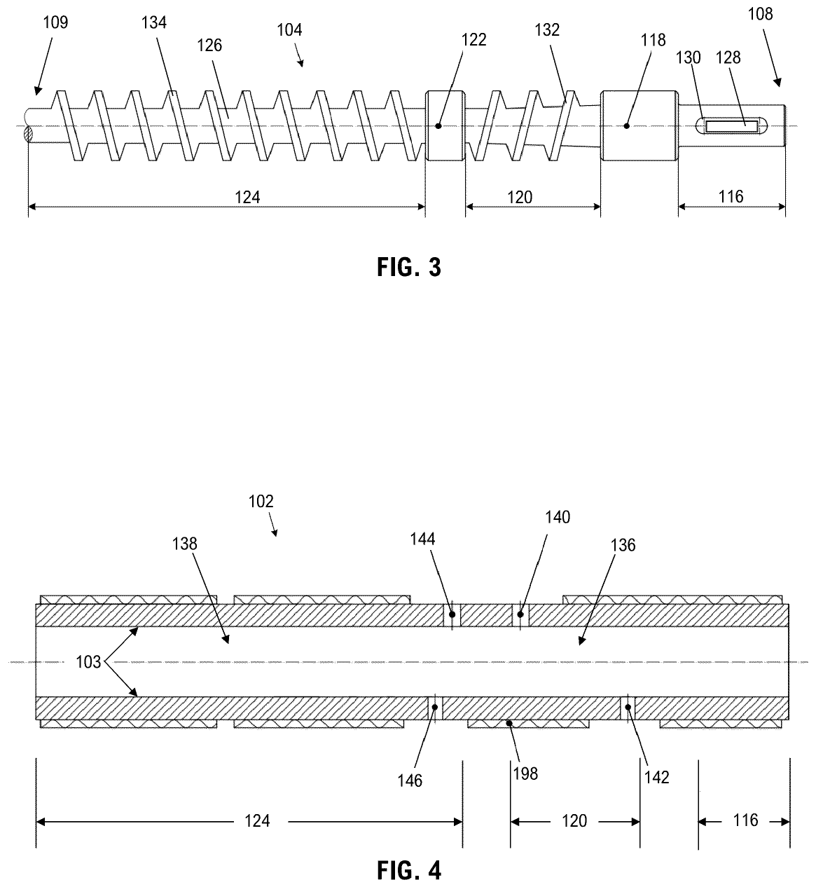

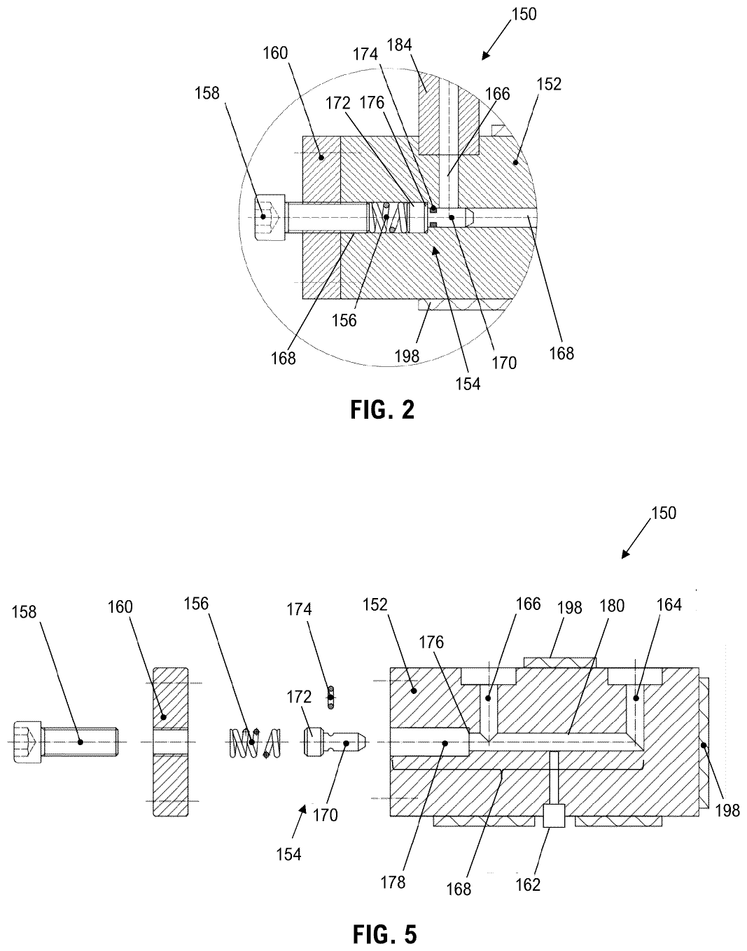

As seen in FIG. 1, bypass valve 150 can communicate with melt cavity 136 and melt extrusion cavity 138 to enable adjustment of the pressure of the homogeneous solution in melt cavity 136. Bypass valve 150 can be connected between the discharge port 142 and the third feed port 146 of feed tube 102. As more particularly seen in FIGS. 2 and 5, bypass valve 150 includes a valve body 152 in which a taper spool 154, also referred to as a cone spool, biased by a spring 156 resides. An adjustment screw 158 extends through an end cap 160 attached to valve body 152 and into a first portion 178, or large diameter hole, of a stepped passage 168, or step hole, in valve body 152. Adjustment screw 158 is retained by end cap 160, such as with threads, so that rotation of adjustment screw 158 will move adjustment screw into or out of first portion 178 of stepped passage 168. A second portion 180, or small diameter hole, of stepped passage 168 continues into valve body 152 from a shoulder 176 between first portion 178 and second portion 180. A diameter of first portion 178 is larger than a diameter of second portion 180, resulting in shoulder 176. Second portion 180 fluidly connects a feed passage 164, or feed hole, of bypass valve 150 with a discharge passage 166, or discharge hole, thereof. A pressure sensor 162 is included to indicate what pressure is present in second portion 180 of stepped passage 168.

Taper spool 154 can include a spool body 170, such as a tapered or cone-shaped body or valve core, and a head 172, also referred to as a flange. Spool body 170 extends into second portion 180 of stepped passage 168 and selectively through an intersection with discharge passage 166. A seal 174 between spool body 170 and valve body 152 in second portion 180 prevents escape of material in second portion 180 into first portion 178. For example, seal 174 can be a seal ring on the spool body 170 at head 172. That is, seal 174 can be arranged between the cone end or spool body 170 of taper spool 154 and the inner wall of the small diameter hole (second portion 180) of the step hole (stepped passage 168) to prevent the homogeneous solution from flowing out of the small diameter hole (second section 180) to the large diameter hole (first section 178). Head 172 of taper spool 154 engages a shoulder 176 of stepped passage 168 when spool body 170 is fully inserted into second portion 180, and spring 156 is placed between adjustment screw 158 and head 172 so that spring 156 resists motion of head 172 away from shoulder 176 when pressurized material enters second portion 180 from feed passage 164. A size and shape of spool body 170 are selected to enable connection or blocking between second portion 180 of stepped passage 168 and discharge passage 166 when spool body 170 slides back and forth in stepped passage 168 responsive to adjustment screw 158 and pressure exerted on spool body 170 by material in second portion 180.

As seen in FIG. 1, feed passage 164 of bypass valve 150 is in fluid communication with discharge port 142 of feed tube 102 via a feed pipe 182, and discharge passage 166 of bypass valve 150 is in fluid communication with third feed port 146 of feed tube 102 via a discharge pipe 184.

As shown in FIG. 1, first feed port 140 and second feed port 144 of feed tube 102 are in fluid communication with a die 202 of foaming extruder 200 through connector 210. Connector 210 has an inlet 212 connected to two outlets 214, 216 by a fluid channel 218, or split passage, arranged in connector 210, where outlets 214, 216 are in fluid communication with first feed port 140 and second feed port 144 of feed tube 102, respectively. Thus, outlets 214, 216 are connected to die 202 of foaming extruder 200 in parallel via fluid channel 218. In addition, a heating device 198, such as an electric heating sleeve or the like, is arranged on the outer surface of feed tube 102 and/or the outer surface of valve body 152 of bypass valve 150.

The axial direction of extrusion screw 104 and feed tube 102 is arranged along the horizontal direction, first feed port 140 and second feed port 144 are arranged at an upper side of feed tube 102, and discharge port 142 and third feed port 146 are arranged at a lower side of feed tube 102. Connector body 210 is at the upper side of feed tube 102, and bypass valve 150 is at the lower side of feed tube 102.

The working process of a supercritical fluid polymer extrusion foaming device based on melt self-sealing according to aspects of the disclosure includes arranging a heating device 198 arranged on feed tube 102 and on bypass valve 150. Feed tube 102 and valve body 152 are heated above the melting temperature of a desired polymer, which is typically about 180° C. When temperature stabilizes, drive system 106 can be started, where the output torque of extruder motor 110 is amplified by transmission 112, which rotates extrusion screw 104. Polymer/supercritical carbon dioxide homogeneous solution formed in foaming extruder 200 is drawn into connector 210 and split through fluid channel 218. Fluid channel 218 delivers the material to melt cavity 136 through first feed port 140 of feed tube 102 and to melt extrusion cavity 138 through second feed inlet 144 of feed tube 102. Because compression section 120 and transport section 124 of extrusion screw 104 have helical threads 132, 134 of opposite orientation, the homogeneous solution entering melt extrusion cavity 138 will be transported continuously toward front end 109 of extrusion screw 104, while the homogeneous solution entering melt cavity 136 will be transported continuously toward rear end 108 of extrusion screw 104. Homogeneous solution in melt cavity 136 is continuously compressed while continuously transported due to the increasing diameter of shaft 126, forming a high-pressure zone of homogeneous solution in melt cavity 136. Subsequently, high-pressure homogeneous solution enters feed passage 164 of bypass valve 150 via feed pipe 182 connected to discharge port 142, then enters second portion 180 of stepped passage 168. At this point, adjustment screw 158 can be turned or rotated so that spring 156 will produce a biasing force exerted on taper spool 154, while observing pressure sensor 162, until the pressure of the homogeneous solution reaches a desired value, such as above the saturation pressure of supercritical carbon dioxide. For example, since the saturation pressure of supercritical carbon dioxide is about 7.38 MPa, the desired pressure value may be about 15 MPa to ensure that supercritical carbon dioxide stays in solution. Thus, a technical effect of aspects of the disclosure is to maintain the pressure of the homogeneous solution in melt cavity at a desired pressure level that inhibits dissolved supercritical carbon dioxide from precipitating from the polymer melt. In addition, any carbon dioxide gas precipitated from the polymer melt cannot pass through the high pressure zone and leak from the rear end 108 of extrusion screw 104, such as through seal section 118. High-pressure homogeneous solution in second portion 180 of stepped passage 168 enters into melt extrusion cavity 138 through discharge passage 166 of bypass valve 150, discharge pipe 184, and third feed port 146 of feed tube 102, which returns the material via transport section 124 of extrusion screw 104 to foaming extruder 200, so that the mixture with the homogeneous solution is continuously extruded to obtain the required microcellular foaming parts.

Embodiments of the disclosure provide various technical and commercial advantages, examples of which are discussed herein. As noted above, a technical effect of embodiments is to provide a supercritical fluid-assisted polymer extrusion foaming device based on self-sealing melt, such that supercritical fluid precipitating from the polymer is retained within the device. A high pressure portion of the working solution of polymer and supercritical fluid is used as its own seal against intrusion of precipitated supercritical fluid, such as carbon dioxide, into the transport section of a solution feed tube. The precipitated gases are otherwise prone to leak from the rear end of the cooling extruder. a technical effect of aspects of the disclosure is to use

The above embodiments are preferred embodiments of the present invention, but the embodiments of the present invention are not limited to the above embodiments. Any other changes, modifications, substitutions, combinations, etc. may be made without departing from the spirit and principles of the present invention. All simplifications should be equivalent substitutions, and are all included in the protection scope of the present invention.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application of such technology and to enable others of ordinary skill in the art to understand the various embodiments of the present disclosure and the possibility of various modifications of the disclosed embodiments, as may be suited to the particular use(s) contemplated.

What is claimed is:

1. An extrusion foaming device, comprising:
a feed tube; and
an extrusion screw arranged in the feed tube for rotation therein, wherein the extrusion screw includes a shaft, a compression section with a first helical thread on the shaft, a separation section on the shaft adjacent the compression section, and a transport section adjacent the separation section opposite the compression section, wherein the transport section includes a second helical thread on the shaft, and wherein a first orientation of the first helical thread is opposite a second orientation of the second helical thread, wherein the first helical thread, the second helical thread, and the separation section have an outer diameter sized to provide a sealing relationship with an inner surface of the feed tube and to allow rotation of the extrusion screw relative to the feed tube, and wherein a diameter of the shaft in the compression section increases along a length of the shaft.

2. The extrusion foaming device of claim 1, further comprising a first feed port through the feed tube at an end of the compression section at which the diameter of the shaft is smallest, a discharge port at an opposite end of the compression section at which the diameter of the shaft is largest, and a drive system connected to the extrusion screw such that rotation of the extrusion screw moves material from the first feed port to the discharge port with the first helical thread.

3. The extrusion foaming device of claim 2, further comprising a bypass valve with a valve body defining a feed passage in fluid communication with the discharge port of the feed tube, a stepped passage in fluid communication with the feed passage, and a discharge passage in fluid communication with the stepped passage, wherein the bypass valve includes a spool body slidably arranged in the stepped passage at an intersection of the stepped passage and the discharge passage, wherein a position of the spool body is adjustable to control a pressure in the stepped passage.

4. The extrusion foaming device of claim 3, wherein the stepped passage of the bypass valve includes a first section and a second section, wherein a diameter of the first section is larger than a diameter of the second section such that a shoulder is formed between the first section and the second section.

5. The extrusion foaming device of claim 4, wherein the spool body is arranged in the second section of the stepped passage, a head is attached to the spool body, and the head is in the first section of the stepped passage, wherein a diameter of the head is larger than the diameter of the second section and the shoulder prevents travel of the head into the second section.

6. The extrusion foaming device of claim 5, wherein an adjustment screw extends from an end of the valve body into the stepped passage to engage the head, and rotation of the adjustment screw changes the position of the spool body.

7. The extrusion foaming device of claim 6, wherein a spring is arranged between the adjustment screw and the head.

8. The extrusion foaming device of claim 6, further comprising a pressure sensor arranged to provide an indication of a pressure in the second section of the stepped passage.

9. The extrusion foaming device of claim 3, wherein the discharge passage of the valve body is in fluid communication with a second feed port through the feed tube.

10. An extrusion foaming device comprising:
a foaming extruder including a die;
a feed tube with an extrusion screw centrally disposed therein and supported for relative rotation thereto, wherein the extrusion screw includes a compression section having a first helical thread with a first orientation, a transport section having a second helical thread with a second orientation that is opposite the first orientation, and a partition section between the compression section and the transport section, wherein the partition section is sized to define a clearance between an outer surface thereof and an inner surface of the feed tube that allows rotation of the partition section relative to the feed tube while impeding flow of material between the compression section and the transport section; and
a connector between the die and the feed tube, the connector defining a fluid channel extending from an inlet at a die end of the connector to first and second outlets at a feed tube end of the connector, wherein the first outlet is in fluid communication with a first feed port of the tube at an end of the compression section of the extrusion screw, and the second outlet is in fluid communication with a second feed port of the feed tube at an end of the transport section of the extrusion screw.

11. The extrusion foaming device of claim 10, wherein the extrusion screw includes a shaft from which the first helical thread and the second helical thread project, an outer diameter of the second helical thread is constant over a length of the compression section, and a diameter of the shaft in the compression section increases along a length of the shaft, thereby defining a melt cavity with the inner surface of the feed tube, the partition section, and a sealing section of the extrusion screw at an end of the compression section opposite the separation section.

12. The extrusion foaming device of claim 10, wherein the clearance between the partition section and the inner surface of the feed tube is from about 0.02 mm to about 0.1 mm.

13. The extrusion foaming device of claim 11, further comprising a discharge port of the feed tube at an end of the compression section opposite the first feed port, and a bypass valve with a valve body defining a stepped passage, a feed passage, and a discharge passage, wherein the feed passage is in fluid communication with the discharge port of the feed tube and with the stepped passage, wherein the discharge passage is in fluid communication with the stepped passage and a third feed port of the feed tube over the transport section of the extrusion screw, and wherein the bypass valve includes a spool slidably disposed in the stepped passage.

14. The extrusion foaming device of claim 13, wherein the spool includes a head in a first section of the stepped passage and a spool body extending from the head into a second section of the stepped passage, the second section having a smaller diameter than the first section and the stepped passage having a shoulder therebetween.

15. The extrusion foaming device of claim 14, wherein an adjustment screw extends into the first section of the stepped passage and a spring is positioned between the adjustment screw and the head of the spool, wherein rotation of the adjustment screw changes a biasing force exerted by the spring on the head of the spool.

16. The extrusion foaming device of claim 15, wherein in operation the foaming extruder includes a homogeneous solution of supercritical fluid and melted polymer that is drawn through the inlet of the connector and into the feed tube via the first and second feed ports, homogeneous solution passing through the first feed port is compressed in the melt cavity by action of the compression section of the extrusion screw and exits the feed tube through the discharge port to enter the bypass valve, whereby the spool maintains a pressure of the homogeneous solution set by rotation of the adjustment screw, wherein the spool body selectively allows homogeneous solution to enter the discharge passage and pass through the third feed port of the feed tube to be moved by the transport section of the extrusion screw.

17. The extrusion foaming device of claim 16, wherein the bypass valve has a pressure sensor configured to detect a pressure in the second section of the stepped passage, and the adjustment screw sets a position of the spool body to maintain a pressure in the second section of the stepped passage above a saturation pressure of the supercritical fluid.

18. An extrusion foaming device comprising:
a foaming extruder in fluid communication with a connector configured to receive a solution of a polymer and a supercritical fluid at an inlet of the connector, wherein the connector defines a fluid channel extending from the inlet to a first outlet and a second outlet in parallel with the first outlet;
a feed tube including a first feed port in fluid communication with the first outlet of the connector, the feed tube further including a discharge port; and
an extrusion screw centrally disposed in the feed tube, wherein the extrusion screw includes a shaft and a first helical thread projecting from the shaft in a compression section of the extrusion screw, wherein the compression section extends between the first feed port of the feed tube and the discharge port of the feed tube, a diameter of the shaft increasing along a length of the shaft from the first feed port of the feed tube to the discharge port of the feed tube.

19. The extrusion foaming device of claim 18, further comprising a bypass valve with a stepped passage in fluid communication with the discharge port of the feed tube and with a second feed port of the feed tube, wherein the extrusion screw further includes a partition section on the shaft between the first feed port and the second feed port.

20. The extrusion foaming device of claim 19, wherein the stepped passage includes a first section and a second section separated by a shoulder, a diameter of the first section is larger than a diameter of the second section, the bypass valve includes a spool body extending into the second section at an intersection of the second section and a valve discharge passage, and the bypass valve includes an adjustment screw extending into the first section in mechanical communication with the spool body, wherein rotation of the adjustment screw changes a position of the spool body in the second section.
